(19) United States
(12) Patent Application Publication
(10) Pub. No.: US 2009/0308774 A1
(43) Pub. Date: Dec. 17, 2009

(54) Methods for Proctecting Glass

(75) Inventors: Hongkyu Kim, Old Bridge, NJ (US); Ronald Walter Mason, Painted Post, NY (US); Himanshu Chandrakant Shah, Painted Post, NY (US); David Alan Tammaro, Painted Post, NY (US)

Correspondence Address: CORNING INCORPORATED, SP-TI-3-1, CORNING, NY, 14831, US

(73) Assignee: Corning Incorporated, Corning, NY (US)

(21) Appl. No.: 12/306,106

(22) PCT Filed: Jun. 26, 2007
(86) PCT No.: PCT/US2007/014843

§ 371 Date: Jul. 24, 2009

Related U.S. Application Data
(60) Provisional application No. 60/816,837, filed on Jun. 27, 2006.

(51) Int. Cl. B65D 85/48; B32B 37/02; B32B 17/06

(52) U.S. Cl. 206/454; 156/60; 156/344; 428/426

(57) ABSTRACT

Described herein are methods for protecting glass with the use of glassine paper.

### BACKGROUND

In recent years, glass substrates for liquid crystal display (LCD) panels have increased in size along with enlargement of liquid crystal display panels. In response to the trend for larger substrate sizes for liquid crystal display, there is a need for suitable packaging for the transfer of large glass substrates (e.g., Gen 5 or greater) to-and-from the glass manufacturer to the display manufacturer (i.e., manufacturers of thin film transistor panels and/or the color filter panels).

In general, when the glass sheets are transported from the liquid crystal display manufacturing plant to a display manufacturer, the glass sheets are typically placed in a crate at the glass sheet manufacturing plant with protective adhesive plastic films attached on either side of each glass sheet prior to transportation. At the liquid crystal panel manufacturing plant, the glass sheets are manufactured into substrates for liquid crystal panels after uncrating the glass sheets, removing the protective films attached on either side of each glass sheet, and cleaning the glass sheets. The cleaning process for removing adherents such as residual adhesive remaining on the glass sheet after removal of the adhesive protective films typically takes a long time. In addition, contaminants can be attached to the glass sheets in the course of transportation of the sheets.

Dense packing glass coated with Visqueen (low density polyethylene) film and separated using interleaf papers has become a standard method to ship Gen 5 and larger sizes of glass, minimize container size, lower shipping costs, and simplify handling issues. However, removal of the film can leave some residual organic materials on the surface of the glass, which must also be washed off with a detergent or the like. This adds to the overall costs and inconvenience to the end-user of the glass.

Thus, there is a need for the packaging of LCD glass sheets with better surface protection between the glass sheets. In particular, there is a need for transporting several large sheets of glass for LCD in a single container yet minimize any damage to the surface of each glass sheet. For example, for transportation of glass sheets to be practical, the prevention of scratches, stains, and residues/contaminants on the glass is desirable. In addition, the protection of the glass must be affordable to the glass manufacturer. The methods described herein provide for the safe and cost-effective transportation of a large number of glass sheets yet protect the glass sheets during transportation from undesirable damage and contaminants.

### SUMMARY

Described herein are methods for protecting glass with the use of glassine paper. The advantages of the materials, methods, and articles described herein will be set forth-in part in the description which follows, or may be learned by practice of the aspects described below. The advantages described below will be realized and attained by means of the elements and combinations particularly pointed out in the appended claims. It is to be understood that both to the foregoing general description and the following detailed description are exemplary and explanatory only and are not restrictive.

### BRIEF DESCRIPTION OF THE DRAWINGS

The accompanying drawings are included to provide a further understanding of the invention, and are incorporated in and constitute a part of this specification. The drawings are not necessarily to scale, and sizes of various elements may be distorted for clarity. The drawings illustrate one or more embodiment(s) of the invention and together with the description serve to explain the principles and operation of the invention.

FIG. 1 shows yield results of several different packing materials.

FIG. 2 shows the shipment/aging effects of several different packing materials.

### DETAILED DESCRIPTION

Before the present materials, articles, and/or methods are disclosed and described, it is to be understood that the aspects described below are not limited to specific compounds, synthetic methods, or uses as such may, of course, vary. It is also to be understood that the terminology used herein is for the purpose of describing particular aspects only and is not intended to be limiting.

In this specification and in the claims that follow, reference will be made to a number of terms that shall be defined to have the following meanings:

Throughout this specification, unless the context requires otherwise, the word “comprise,” or variations such as “comprises” or “comprising,” will be understood to imply the inclusion of a stated integer or step or group of integers or steps but not the exclusion of any other integer or step or group of integers or steps.

It must be noted that, as used in the specification and the appended claims, the singular forms “a,” “an” and “the” include plural referents unless the context clearly dictates otherwise. Thus, for example, reference to “a pharmaceutical carrier” includes mixtures of two or more such carriers, and the like.

“Optional” or “optionally” means that the subsequently described event or circumstance can or cannot occur, and that the description includes instances where the event or circumstance occurs and instances where it does not.

Described herein are methods for protecting glass. In one aspect, described herein is a method for protecting glass for a liquid crystal display, comprising applying to at least one surface of the glass a glassine paper, wherein an adhesive is not used to attach the paper to the surface of the glass.

The term “glassine paper” as used herein is defined as super-calendared paper manufactured principally from chemically-bleached wood pulps that have been beaten to secure a high degree of stock hydration. Glassine paper is generally grease resistant. Glassine paper is dense, which results in a paper having a high resistance to the passage of air and relatively impervious to the passage of water vapor when compared to other paper products. It is also smooth and transparent or semi-transparent. Glassine paper generally has a low inorganic content, which is generally present in other types of paper. Due to the lack of fillers, binders, resins and other additives, any organic contaminants are minimized, and stain formation on the glass surface is prevented. Inorganic contaminants present in the paper are generally locked within the paper by processing, which prevents subsequent scratching of the glass surface. Glassine paper can be manufactured so that it is translucent, white, or colored, and may also be made opaque by the addition of fillers.

As discussed above, particle-free sheets (substrates) of LCD glass are of importance since they are the starting point for determining the quality of the LCD thin-film transistors formed on the sheets. Glassine paper possesses numerous properties that minimize particle formation when the paper is in contact with the glass substrate. In one aspect, the glassine paper has a residue content of less than or equal to 0.2% as measured by an ashing test or sample preparation for ICP/MS. Both of these techniques are known in the art. The ashing test involves combusting the paper and measuring the final amount of combustion product that remains after combustion, where the amount is the weight percent of the paper prior to combustion. In one aspect, the glassine paper has a residue content of less than or equal to 0.1% as measured by an ashing test or sample preparation for ICP/MS. A lower residue content is desirable as this ultimately reduces the possibility of the glassine paper from scratching or staining of the LCD glass.

In another aspect, the glassine paper has a side/side smoothness rating of 170/170, preferably 115/145 as measured by Sheffield smoothness, a technique known in the art. In this aspect, the smoothness of one side of the paper is measured in view of the other side. The smoother the surface of the paper, the less likely the paper surface will scratch or stain the glass surface.

In a further aspect, the glassine paper has a particle shedding number less than 4,000 particles/minute of ≧0.3 micron particle diameter as measured by the Helmke Drum test. The Helmke Drum test involves loading 3 to 4 swatches of paper of a given type into an ss drum. The total paper area is about 432 in² cut into three sheets (12 in ×12 in). The drum is rotated at 0.1 rpm, and then a laser particle count is performed to measure the number of particles. In one aspect, the particle shedding number is less than 4,000, less than 3,500, less than 3,000, or less than 2,500. In another aspect, the particle shedding number is from 300 to 4,000, 300 to 3,500, 600 to 3,000, 1,000 to 3,000, 1,500 to 3,000, 2,000 to 3,000, or 2,500 to 3,000.

The stiffness of the paper also needs to be considered particularly when stacking multiple glass sheets. In one aspect, the glassine paper has a machine direction stiffness and a cross direction stiffness greater than or equal to 0.3 g/cm as measured by Taber stiffness, which is a technique known in the paper field. In one aspect, the glassine paper has a machine direction stiffness of 0.3 to 2.0, 0.5 to 1.8, 0.7 to 1.6, or 1.2 to 1.4 g/cm and a cross direction stiffness of 0.3 to 1.5, 0.5 to 1.3, 0.6 to 1.1, or 0.6 to 0.8 g/cm 0.7 g/cm as measured by Taber stiffness. In another aspect, the glassine paper has a machine direction stiffness of 1.3 g/cm and a cross direction stiffness of 0.7 g/cm as measured by Taber stiffness.

The weight and thickness of the glassine paper can vary depending upon the type of paper selected and the dimensions of the LCD glass to be protected. In one aspect, the glassine paper has a basis weight of 20 to 80 lb/3000 Ft², 30 to 70 lb/3000 F², 30 to 60 lb/3000 Ft², 30 to 50 lb/3000 Ft², 30 to 40 lb/3000 Ft², or 37 to 41 lb/3000 Ft². In another aspect, the glassine paper has a Mil thickness of 1 Mil to 10 Mil, 1 Mil to 9 mil, 1 mil to 8 mil, 1 mil to 7 mil, 1 mil to 6 mil, 1 mil to 5 mil, 1 mil to 4 mil, 1 mil to 3 mil, 2 mil to 3 mil, or 2 mil to 2.6 mil.

In one aspect, the glassine paper is derived from bleached virgin pulp that does not contain any coatings, binders, resins, or dyes. In other aspects, the glassine paper is not produced from recycled materials. In certain aspects, the glassine paper comprises an anti-microbial agent, a foam control, and/or a pitch control. In another aspect, the glassine paper comprises no dyes or at most a nominal amount of dye. In one aspect, glassine paper manufactured by Thilmany LLC can be used herein. It is contemplated that the glassine paper can be processed further to remove any components that may stain or scratch the LCD glass. For example, the glassine paper WR-180 manufactured by Thilmany LLC can be processed to remove any dyes present in the paper, which is useful in the methods described herein for protecting glass.

The methods for protecting LCD involve applying to at least one surface of the glass a glassine paper. The application of the paper to the glass surface does not require the use of adhesives, which can introduce contaminants that require additional process steps to remove from the glass.

The glassine paper protects the glass from a number of undesirable events. For example, the glassine paper reduces or prevents scratching of the glass surface. Not only does the paper prevent scratching from external sources (e.g., another glass sheet), the paper itself does not scratch the glass surface or, at most, slightly scratches the surface. In one aspect, when the glassine paper is removed from the glass, the glass has a scratch rating less than 100 particles/cm², less than 75 particles/cm², less than 50 particles/cm², or 25 to 40 particles/cm² as measured by a dark field inspection technique using a strobe light source and particle counter. The dark field inspection technique is known in the art by LCD panel manufacturers. It is an automated visual inspection system that measures the gain in particle density on the surface of the glass after removal of the glassine paper. As discussed above, glassine paper generally has a low inorganic content, which is generally present in other types of paper at higher concentrations. Inorganic contaminants present in the paper are generally locked within the glassine paper by processing, which prevents subsequent scratching of glass surfaces upon contact with the glassine paper.

In another aspect, the glassine paper reduces or prevents staining of the glass surface. As discussed above, due to the lack of fillers, binders, resins and other additives, any organic contaminants are minimized, and stain formation on the glass surface is prevented. In one aspect, when the glassine paper is removed from the glass, the glass has a stain rating of less than 25 particles/cm², less than 20 particles/cm², less than 15 particles/cm², or less than 10 particles/cm² as measured by a dark field inspection technique using a strobe light source and particle counter.

The methods described herein are useful for protecting a plurality of stacked glass sheets for a liquid crystal display. In one aspect, a sheet of glassine paper is inserted between each glass sheet. The insertion of the sheet of glassine paper can be performed manually or it can be automated with the use of conveyors and robots. In one aspect, when a plurality of glass sheets are to be protected, a package system can be produced. In this aspect, the package system comprises a container, a plurality of glass sheets, and a plurality of glassine paper sheets, wherein the container encloses the plurality of glass sheets, and wherein a glassine paper sheet is inserted between each sheet of glass. Optionally, a bag can be used to wrap the glass sheets with interleaf material prior to loading into the container. The bags disclosed in U.S. published application no. 20050194279, which are incorporated by reference in their entirety, can be used in this aspect. This can further protect the glass sheets from exposure to moisture and particulates. The techniques and packaging systems described herein are useful in protecting and storing large glass sheets (Gen 5 and above), which become even more unwieldy for operators to handle. The glass sheets can be washed after removal of the glassine paper using techniques known in the art, which includes the use of roller brushes, disc brushes, aqua knives, ultrasound, and any combination thereof. It is desirable to use highly pure water when a washing step is performed.

The methods described herein provide numerous advantages with respect to protecting LCD glass. In most aspects, a single sheet of glassine paper interleaf material is used to protect and separate glass sheets. In current applications, the glass paper interleaf sheet is normally packed between film surfaces to prevent films from sticking. Using the methods described herein, the single glassine sheet interleaf functions both to protect the glass sheets in transit, and is easily separable from the glass without special equipment.

The glassine paper interleaf does not require the use of a large film coating and removal apparatus. The paper also greatly simplifies the packing process, the handling of larger glass sheets, and reduces capital costs of equipment and operational costs. The glassine paper also provides surface protection that is as good if not better than other materials used in the market. Moreover, the glassine paper can be recycled, which reduces overall processing costs. Finally, the glassine paper is substantially less expensive when compared to other materials used to protect glass sheets. For example, WR-180, which is an example of a glassine paper useful herein, is approximately two- to three times less expensive than Visqueen, which is currently used to protect LCD glass sheets.

### EXAMPLES

The following examples are put forth so as to provide those of ordinary skill in the art with a complete disclosure and description of how the materials, articles, and methods described and claimed herein are made and evaluated, and are intended to be purely exemplary and are not intended to limit the scope of what the inventors regard as their invention. Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of reaction conditions, e.g., component concentrations, desired solvents, solvent mixtures, temperatures, pressures and other reaction ranges and conditions that can be used to optimize the product purity and yield obtained from the described process. Only reasonable and routine experimentation will be required to optimize such process conditions.

### I. Lab Testing

a. Stain and Scratch Defects

The presence of stain and scratch defects are important considerations when evaluating different materials (e.g., paper) for protecting glass. With respect to measuring stain defects, 16 hour/50° C./85% relative humidity (rh) aging tests to target the potential stain from papers to glass were used as a screening tests.

A scratch test was developed to evaluate motion of the materials rubbed across the glass surface. This test used a simple flat-bottomed container with the paper attached to the base, to ride across the glass (5″×5″ surface) in a repeatable way (10×). Once this test was complete, results after washing were compared using a particle density instrument. In addition to scratch and stain, other paper properties related to scratch and stain were tested in order to evaluate the interleaf materials, which are shown in Table 1.

TABLE 1
Lab testing summary.

| | Stain | Scratch |
|---|---|---|
| new materials | 69 | 43 |
| measurements | 7160 | 1260 |

| method | material |
|---|---|
| Infrared | 40 |
| ICP-MS | 28 |
| TGA | 28 |
| % water | 27 |
| pH -Conductivity | 14 |
| TOF/SIMS | 11 |
| Smoothness | 11 |
| Caliper | 8 |
| Basis | 8 |
| Stiffness | 10 |
| Friction | 6 |

The water content was thought to influence sticking of fibers and paper components to the surface of glass through hydrogen bonding. The pH-conductivity test was a method to watch the contaminants come out of paper into a vessel of water, which is a measure of potential scratch and stain causing contents. The other tests were related to either scratch and stain issues or to basic paper properties that would be required for handling large sheets using robots to pack containers.

Testing was completed on over 80 different types of papers, composite papers, polymer papers, polymer-impregnated papers, non-wovens, and coated papers. To judge the results, weighting factors for the key test measures were established as shown in Table 2.

TABLE 2

| | |
|---|---|
| Scratches: Use 5 × 5 pre-clean glass, use dried paper, | (WF = 10) |
| translate paper across glass, reclean, remeasure. | |
| Stains: Use 5 × 5 pre clean glass, use humidified paper, | (WF = 5) |
| age 16 hours in 23 g/cm2 stack, rewash, remeasure. | |
| Residue: Use ICP-MS and TG data | (WF = 2) |
| Sheffield Smoothness | (WF = 2) |
| Water Absorption. | (WF = 1) |
| Basis Weight | (WF = 1) |

The evaluation led to three candidates that were chosen from lab testing to advance into the container shipment and aging tests. The lower the numerical score the better the performance. The candidates are:

1. MeadWestvaco, polyethylene coated paper. This was a wood pulp paper coated with polyethylene, deemed to be the closest surface composition to the current Visqueen film. It was also the heaviest weight paper.
2. Thilmany Paper WR-139, a glassine paper, is a hydrated and densified wood pulp paper.
3. FiberMark Lahnstein Varitess 210.03 is a polymer-impregnated commercial paper. This paper was 59% pulp and 40% synthetic with PET, acrylate contents.

TABLE 3

| Paper | Stain | | Scratch | | Residue | | Smoothness | | | Final |
|---|---|---|---|---|---|---|---|---|---|---|
| Name | Rank | Wt. Factor | Rank | Wt. Factor | Rank | Wt. Factor | Rank | Wt. Factor | Score | Rank |
| WR-139 | 3 | 5 | 2 | 10 | 3 | 2 | 1 | 2 | 43 | 1 |
| MWV PE Coated Paper | 5 | 5 | 1 | 10 | 2 | 2 | 2 | 2 | 43 | 2 |
| Varitess 210.030 | 1 | 5 | 2 | 10 | 3 | 2 | 7 | 2 | 45 | 3 |
| Pretex 482.050 | 4 | 5 | 2 | 10 | 1 | 2 | 4 | 2 | 50 | 4 |
| RL-241 | 2 | 5 | 3 | 10 | 4 | 2 | 2 | 2 | 52 | 5 |
| Typar 3021N | 6 | 5 | 2 | 10 | 1 | 2 | 7 | 2 | 66 | 6 |
| Crane 32-74 | 7 | 5 | 2 | 10 | 5 | 2 | 5 | 2 | 75 | 7 |
| FiberMark W13 | 8 | 5 | 2 | 10 | 3 | 2 | 6 | 2 | 78 | 8 |

Table 4 shows the Visqueen performance with the competitive materials: Kirari D (used by Asahi) and Milla-Mat-Ace (a foam used by NEG). Table 4 also includes various interleaf properties, for comparison.

TABLE 4

| | Kirari-D | Milla Mat Ace | PE Coated Paper | Varitess 210.030 | WR-139 | Visqueen |
|---|---|---|---|---|---|---|
| Stain, Median | 5.6 | | 2.3 | 0.7 | 1.3 | 2.3 |
| Stain, Average | 8.5 | 645.1 | 4.7 | 2.7 | 2.5 | 4.3 |
| Scratch, Average | 70.6 | | 12.0 | 31.8 | 29.7 | 9.6 |
| TGA, % water | 5.5 | | 4.1 | 3.9 | 6.4 | |
| TGA, % Residue | 1.5 | | 0.3 | 0.2 | 0.3 | |
| ICP-MS, % Residue | 0.3 | | 0.2 | 0.2 | 0.2 | |
| Water Absorption % | 6.6 | | 6.7 | 4.3 | 7.9 | |
| pH, 30 min. | 4.6 | | | 5.4 | 4.7 | |
| conductivity, 30 min, μS | 5.0 | | | 8.1 | 11.6 | |
| Sheffield Smoothness, 1 | 280 | | 151 | 406 | 115 | |
| Sheffield Smoothness, 2 | 280 | | 88 | 406 | 145 | |
| Coef friction, Static | 0.32 | | 0.71 | 0.31 | 0.31 | |
| Coef Friction, Kinetic | 0.38 | | 0.98 | 0.37 | 0.38 | |
| Taber Stiffness, MD | 0.3 | | 7.7 | 0.5 | 1.3 | |
| Taber Stiffness, CD | 0.4 | | 3.8 | 0.4 | 0.7 | |
| Basis lbs/3000 sq. ft | 21.5 | | 73.2 | 18.8 | 38.4 | |
| caliper mil | | 39.8 | 5.6 | 4.4 | 2.4 | |
| density | | | 13.1 | 4.3 | 16.0 | |

### II. Container Testing

### Procedures

Table 5 shows the crate-packing scheme involved for randomizing lots of the six packing types in four containers. There were three packing container sequences followed with one sequence repeated for both a control and a shipped container. After aging and shipment, the glass surface was re-examined.

TABLE 5

| Crate 1, AND Crate 2 | type 1 | Crate 3 | | Crate 4 | |
|---|---|---|---|---|---|
| Control Crate, AND 1 Shipped Crate | | Shipped for Aging | type 2 | Shipped for Aging | type 3 |
| Packing Material | # of Sheets | Packing Material | # of Sheets | Packing Material | # of Sheets |
| Visqueen | 40 | Visqueen | 40 | Visqueen | 40 |
| MWV PE Coated Paper | 40 | Varitess 210.030 | 40 | Milla-Mat Ace | 19 |
| Varitess 210.030 | 40 | WR-139 | 40 | Kirari-D | 40 |
| WR-139 | 40 | Milla-Mat Ace | 20 | WR-139 | 40 |
| Kirari-D | 40 | Visqueen | 20 | Visqueen | 20 |
| Varitess 210.030 | 40 | Kirari-D | 40 | MWV PE Coated Paper | 37 |
| MWV PE Coated Paper | 40 | Visqueen | 19 | Visqueen | 20 |
| Milla-Mat Ace | 20 | MWV PE Coated Paper | 40 | Varitess 210.030 | 40 |
| Kirari-D | 40 | WR-139 | 40 | Kirari-D | 40 |
| WR-139 | 40 | Varitess 210.030 | 40 | WR-139 | 40 |
| Visqueen | 40 | Kirari-D | 40 | MWV PE Coated Paper | 40 |
| | | MWV PE Coated Paper | 40 | Varitess 210.030 | 40 |

| | Control | Crate 2 | Crate 3 | Crate 4 | Total |
|---|---|---|---|---|---|
| Visqueen | 80 | 80 | 79 | 80 | 319 |
| MWV PE Coated Paper | 80 | 80 | 80 | 77 | 317 |
| Varitess, polymer impreg | 80 | 80 | 80 | 80 | 320 |
| WR-139, glassine | 80 | 80 | 80 | 80 | 320 |
| MM Ace Foam (NEG) | 20 | 20 | 20 | 19 | 79 |
| Kirari D (Asahl) | 80 | 80 | 80 | 80 | 320 |
| Sums | 420 | 420 | 419 | 416 | 1675 |

### Surface Yields

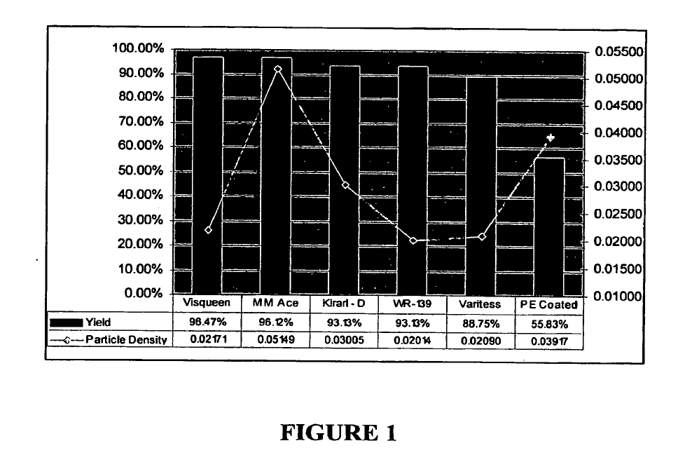

The surface yields of the glass surfaces were determined using various particle count techniques and surface defect identification techniques, with the results shown in FIG. 1. Visqueen had the best results, followed by Milla-Mat-Ace (MM Ace), then WR-139 and Kirari D. The Varitess and PE Coated papers had poorer yields. A high count of surface defects remaining on glass with MM Ace was observed. The two highest performance papers were Kirari D and WR-139 with approximately 3% yield loss versus Visqueen.

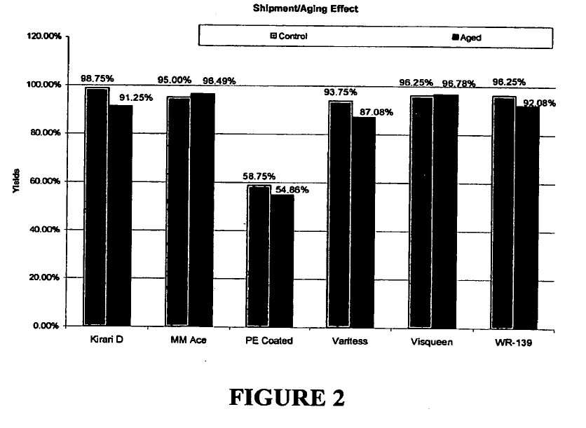

Comparison of yields for non-shipment and aging versus shipment and aging conditions is shown in FIG. 2. This comparison shows that the yield differences for Visqueen and the MM Ace are not significantly different between control and shipped samples. For the other single layer interleaf samples, however, all materials show a consistent drop in yield with shipment and aging.

### Surface Defects and Distribution

The number of defects (e.g., surface scratches, particles, and stains) for each packaging material was determined, and the results are shown in Table 6. For each material, approximately 320 sheets were tested with the exception of MM Ace, where only 80 sheets were tested. In addition, previous lab testing revealed that MM Ace had an unacceptable level of staining.

TABLE 6

| Material | Number of Defects |
|---|---|
| Kirari D | 319 |
| MM Ace | 74 |
| Polyethylene coating | 658 |
| Varitess | 390 |
| Visqueen | 366 |
| WR-139 | 311 |

The results indicate that WR-139 has a number of defects in the range of other materials, particularly Visqueen.

Throughout this application, various publications are referenced. The disclosures of these publications in their entireties are hereby incorporated by reference into this application in order to more fully describe the compounds, compositions and methods described herein.

Various modifications and variations can be made to the materials, methods, and articles described herein. Other aspects of the materials, methods, and articles described herein will be apparent from consideration of the specification and practice of the materials, methods, and articles disclosed herein. It is intended that the specification and examples be considered as exemplary.

What is claimed:

1. A method for protecting a glass sheet for a liquid crystal display, comprising applying to at least one surface of the glass a glassine paper, wherein an adhesive is not used to attach the paper to the surface of the glass.

2. The method of claim 1, wherein when the glassine paper is removed from the glass, the glass has a scratch rating less than 100 particles/cm² as measured by a dark field inspection technique using a strobe light source and particle counter.

3. The method of claim 1, wherein when the glassine paper is removed from the glass, the glass has a scratch rating of 25 to 40 particles/cm² as measured by a dark field inspection technique using a strobe light source and particle counter.

4. The method of claim 1, wherein the glassine paper reduces or prevents staining of the glass surface.

5. The method of claim 1, wherein when the glassine paper is removed from the glass, the glass has a stain rating of less than 25 particles/cm² as measured by a dark field inspection technique using a strobe light source and particle counter.

6. The method of claim 1, wherein when the glassine paper is removed from the glass, the glass has a stain rating of less than 10 particles/cm² as measured by a dark field inspection technique using a strobe light source and particle counter.

7. The method of claim 1, wherein the glassine paper has a residue content of less than or equal to 0.2% as measured by an ashing test or sample preparation for ICP/MS.

8. The method of claim 1, wherein the glassine paper has a residue content of less than or equal to 0.1% as measured by an ashing test or sample preparation for ICP/MS.

9. The method of claim 1, wherein the glassine paper has a side/side smoothness rating of 170/170 as measured by Sheffield smoothness.

10. The method of claim 1, wherein the glassine paper has a side/side smoothness rating of 115/145 as measured by Sheffield smoothness.

11. The method of claim 1, wherein the glassine paper has a basis weight of 20 to 80 lb/3000 Ft².

12. The method of claim 1, wherein the glassine paper has a basis weight of 37 to 41 lb/3000 Ft².

13. The method of claim 1, wherein the glassine paper has a thickness of 1 to 10 mil.

14. The method of claim 1, wherein the glassine paper has a thickness of 2 to 2.6 mil.

15. The method of claim 1, wherein the glassine paper has a particle shedding number less than 4,000 particles/minute of ≧0.3 micron particle diameter as measured by the Helmke Drum test.

16. The method of claim 1, wherein the glassine paper has a machine direction stiffness and a cross direction stiffness greater than or equal to 0.3 g/cm as measured by Taber stiffness.

17. The method of claim 1, wherein the glassine paper has a machine direction stiffness of 1.3 g/cm and a cross direction stiffness of 0.7 g/cm as measured by Taber stiffness.

18. A glass protected by the method of claim 1.

19. A method for protecting a plurality of stacked glass sheets for a liquid crystal display, comprising inserting between each sheet of glass a sheet comprising a glassine paper.

20. A package system with a plurality of glass sheets for a liquid crystal display comprising a container, a plurality of glass sheets, and a plurality of glassine paper sheets, wherein the container encloses the plurality of glass sheets, and wherein a glassine paper sheet is inserted between each sheet of glass.
